(19) United States
(12) Patent Application Publication
(10) Pub. No.: US 2023/0094254 A1
(43) Pub. Date: Mar. 30, 2023

(54) Method and Display Equipment for Displaying a Key Parameter of a Food Treatment Machine and a Food Treatment Machine

(71) Applicant: GEA Food Solutions Germany GmbH, Biedenkopf-Wallau (DE)

(72) Inventors: Nelson Da Costa Moreira, Biedenkopf (DE); Michael Heising, Ahlen (DE); Sascha Bieletzki, Bönen (DE); Thomas Immich, Saarbrücken (DE)

(21) Appl. No.: 17/908,988

(22) PCT Filed: Mar. 3, 2021
(86) PCT No.: PCT/EP2021/055318

§ 371 Date: Sep. 2, 2022

(30) Foreign Application Priority Data
Mar. 4, 2020 (DE) 102020202772.2
Jul. 8, 2020 (DE) 102020208588.9

(51) Int. Cl. G06F 3/04847; A23P 30/00; B65B 57/18

(52) U.S. Cl. CPC G06F 3/04847; A23P 30/00; B65B 57/18

(57) ABSTRACT

A method for displaying a key parameter of a food treatment machine, a food processing machine, or a food packaging machine, the method includes displaying a time history of the key parameter from a first time in the past to a current time on a first display region of a display equipment, and for at least one event that has occurred between the first time and the current time, an event position is determined in the first display region, and an event symbol is displayed at the determined event position in the first display region.

### CROSS-REFERENCE TO RELATED APPLICATIONS

This application is a US National Phase of PCT/EP2021/055318 filed on Mar. 3, 2021, which claims priority to DE 10 2020 202 772.2 filed on Mar. 4, 2020 and DE 10 2020 208 588.9 filed on Jul. 8, 2020, all of which are hereby incorporated by reference herein for all purposes.

### FIELD

The present invention relates to a method for displaying a key parameter of a food treatment machine, more particularly a food processing machine or a food packaging machine, by means of display equipment on the food treatment machine, wherein a time history of the key parameter from a first time in the past to a current time is displayed in a first display region of the display equipment. The invention further relates to display equipment for a food treatment machine, more particularly a food processing machine or a food packaging machine, which equipment is designed to display a time history of a key parameter from a first time in the past to a current time in a first display region of the display equipment. A further subject matter of the invention is a food treatment machine, more particularly a food processing machine or a food packaging machine, having display equipment.

### BACKGROUND

As a rule, food treatment machines, such as, for example, food processing machines and food packaging machines, have display equipment in which information on the status of the food treatment machine can be displayed. It is often possible to display a time history of a key parameter from a first time in the past to a current time. Thus, for example, WO 2010/091 989 A1 describes a food processing machine like a centrifuge in the display equipment of which a history of a parameter is displayed.

The display of the history allows the user to develop an image of the current status of the machine. In particular in such situations in which the user has changed, for instance when there is shift change, it is often difficult for the user to detect the current status of the machine without additional information from a previous user.

### SUMMARY

The object of the present invention is to make it easier for a user to detect the current status of the food treatment machine, in particular after a user or shift change.

In one method of the type mentioned in the foregoing, for attaining the object it is proposed that, for at least one event that has occurred between the first time and the current time, an event position is determined in the first display region and an event symbol is displayed at the determined event position in the first display region.

Due to the inventively provided simultaneous display of the history of the key parameter and the at least one event symbol in the first display region, it is possible for a user to more easily detect a temporal context between the event and the history of the key parameter. The user can assess the history of the key parameter in the region of the event symbol—that is, during the time in which the associated event occurred—in connection with the event and more easily produce a connection between the event and the history. Thus, it is more easily possible to detect the current status of the machine, especially when there is a change in user or a shift change.

The time history of the key parameter is preferably displayed as a curve, in particular a graph, over time. The time can be plotted on a first coordinate axis and a value, in particular an absolute value, of the key parameter can be plotted on a second coordinate axis. It is not necessary for coordinate axes to be displayed, but this can be provided.

It is preferably provided that, for each of a plurality of events that have occurred between the first time and the current time, one event position is determined in the first display region and one event symbol is displayed at each determined event position in the first display region. The at least one event position, preferably the plurality of event positions, can be determined by means of a computing unit for the food treatment machine, in particular the display equipment of the food treatment machine.

The at least one event, preferably the plurality of events, can be machine events and/or user events and/or protocol events and/or external events. Machine events are understood to be events triggered by the food treatment machine or a component of the food treatment machine, such as, for example, a warning message or a fault condition. A warning message can be produced, for example, when a certain component has a temperature that is too high or too low, or the level of a consumable for the food treatment machine is too low or is completely empty. User events are events that are triggered by an input or actuation on the part of a user and recorded by the machine, for example, starting the food treatment machine, selecting a recipe, or adjusting an input parameter of the food treatment machine. Protocol events are understood to be events triggered by an input or actuation on the part of a user and not recorded by the machine, but rather documented by the user, in particular an input into the food treatment machine on the part of the user, for example the addition of consumables or foods to be processed. External events are understood to be events triggered outside of the specific food treatment machine, for example in a further food treatment machine, in particular a further food treatment machine of a common line.

According to one advantageous embodiment of the invention, it is provided that an event interval is allocated to the at least one event, wherein a starting position for the event interval and an ending position for the event interval in the first display region are determined and an event interval symbol, in particular a bar symbol, is displayed between the determined starting position and the determined ending position. Due to the display of the event interval symbol, it is possible to depict a connection between the history of the key parameter and an event that occurred in a time interval rather than at a singular point in time. Such an event may be, for example, a disturbance in a component or in the entire food treatment machine. It is preferably provided that for a plurality of events, to each of which an event interval is allocated, a starting position for the event interval and an ending position for the event interval are determined in the first display region and an event interval symbol, in particular a bar symbol, is displayed between the determined starting position and the determined ending position.

One advantageous embodiment of the invention provides that a marking is displayed at a current position corresponding to the current time. The marking makes it easier to find the current value of the key parameter and read the latter from display equipment. The marking can be embodied, for example, as a point, circle, and/or vertical bar, so that it is possible to provide a marking that is easy to detect rapidly with the naked eye.

One embodiment has proved advantageous in which the display device has a second display region, wherein an event position for at least one future event, in particular a planned or forecasted event, in the second display region is determined and an event symbol is displayed at the determined event position in the second display region. The display of the future events in the second display region makes it even easier to detect the current status of the food treatment machine. For example, a planned shift change, planned change in the product to be produced, the forecasted refilling of a consumable, or the forecasted time for maintenance and/or cleaning of a component for the entire food treatment machine can be displayed as a future event. It is preferably provided that one event position in the second display region is determined for each of a plurality of future events and one event symbol is displayed at each determined event position in the second display region.

In this context, it is particularly advantageous if one event interval is allocated to the at least one future event, wherein a starting position for the event interval and an ending position for the event interval in the second display region is determined and an event interval symbol, in particular a bar symbol, is displayed between the determined starting position and the determined ending position. Due to the display of the event interval symbol, it is possible to depict a connection between the history of the key parameter and an event that will occur in a time interval rather than at a singular point in time. In addition, due to the display of the event interval symbol, an event is depicted, the future point in time of which is uncertain—the event interval symbol can symbolize the time interval in which the event is highly likely to occur. It is preferably provided that for a plurality of events, to each of which an event interval is allocated, a starting position for the event interval and an ending position for the event interval in the second display region is determined and an event interval symbol, in particular a bar symbol, is displayed between the determined starting position and the determined ending position.

According to one advantageous embodiment, it is provided that the first display region and the second display region are arranged connecting to one another, in particular adjacent to one another, wherein the second display region is preferably arranged to the right of the first display region. In this way a depiction in the display equipment can be attained in which the history of the key parameter and the event symbols are depicted from left to right in chronologically ascending order. This allows the user of the food treatment machine to intuitively detect the history and events.

In this context, it is advantageous for the event interval symbol to extend from the first display region into the second display region, for example if both the starting position and the ending position for the event interval are originally determined in the second display region, but at or after the time of the starting position has been achieved, this starting position shifts into the first display region.

One advantageous embodiment provides that the display equipment includes a touch-sensitive screen, for example a touch-screen. In this way the display equipment can be part of operating and display equipment via which information can be displayed and also operating commands, for example, touching a region of the screen or making a swiping gesture, can be received.

In one advantageous embodiment, a third display region is provided that is embodied as a menu strip and includes one or a plurality of menu symbols. It can be provided that the first and second display regions and/or the third display region are always visible when the display equipment is activated.

According to one advantageous embodiment, it is provided that when the event symbol is selected by a user, for example by touching the event symbol, contextual information about the event is displayed in the display device. The contextual information can be displayed in a fourth display region. The fourth display region is preferably arranged separately from the first and second and third (if any) display region, for example above the first and second display regions. Alternatively, it can be provided that the fourth display region covers the first and/or second display region, entirely or in part.

According to one advantageous embodiment, it is provided that when a user touches the display equipment or performs a swiping gesture on the display equipment, there is a switch back and forth between a first depiction status and a second depiction status, wherein in the first depiction status the first display region and the second display region (if any) are depicted smaller than in the second depiction status. In the first depiction status, the first display region and the second display region (if any) assume a smaller portion of the display surface area of the display equipment, so that a larger quantity of additional information and/or operating elements can be displayed in the rest of the display surface area. In the second depiction status, this residual display surface area is smaller, while more surface area is available for depicting the first display region and the second display region (if any).

In this context it is advantageous when the history of the key parameter is displayed with a lower detail accuracy in the first depiction status than in the second depiction status. Such an embodiment of the method offers the advantage that the user can take more detailed information on the history and the at least one event from the first display region and second display region (if any) than in the first depiction status.

A priority is preferably allocated to the at least one event, wherein a display color is determined using the priority and the event symbol and the event interval symbol (if any) are displayed in the determined display color. This can support the user in differentiating events of different priority from one another. For example, different display colors can be allocated to different priorities.

According to one advantageous embodiment, it is provided that a key parameter list of prespecified key parameters is displayed in the display equipment, wherein when a user selects a key parameter from the key parameter list, a time history of the selected key parameter from the first time in the past to the current time is displayed in the first display region. Such an embodiment offers the advantage that the display equipment can be used for displaying different key parameters for the food treatment machine.

In this context, it is advantageous when a key parameter selection symbol is displayed in the display equipment, and, when a user selects the key parameter selection symbol, the key parameter list is displayed. This improves the ease of use of the display equipment. The key parameter list can open in the manner of a drop-down menu when the key parameter selection symbol is selected.

According to one advantageous embodiment it is provided that an event type is allocated to the at least one event and an event type list of prespecified event types is displayed in the display equipment, wherein when a user selects an event type from the event type list, only events of the selected event type are displayed in the first display region and the second display region (if any). Preferably a plurality of event types can be selected at the same time. In this context, it is advantageous when an event type selection symbol is displayed in the display equipment, and, when a user selects the event type selection symbol, the event type list is displayed. This improves the ease of use of the display equipment. The event type list can open in the manner of a drop-down menu when the event type selection symbol is selected.

One further subject matter of the invention is display equipment for a food treatment machine, in particular a food processing machine or a food packaging machine, that is designed to display a time history of a key parameter from a first time in the past to a current time in a first display region of the display equipment, wherein the display equipment is further designed to determine an event position in the first display region for at least one event that occurred between the first time and the current time, and to display an event symbol at the determined event position in the first display region.

According to one advantageous embodiment of the display equipment, it is provided that an event interval is allocated to the at least one event and the display equipment is further designed to determine a starting position for the event interval and an ending position for the event interval in the first display region, and to display an event interval symbol, in particular a bar symbol, between the determined starting position and the determined ending position.

One advantageous embodiment provides that the display equipment has a second display region, wherein the display equipment is further designed to determine for at least one future event, in particular one planned or forecasted event, an event position in the second display region, and to display an event symbol at the determined event position in the second display region.

According to one advantageous embodiment, it is provided that an event interval is allocated to the at least one future event, wherein the display equipment is further designed to determine a starting position for the event interval and an

ending position for the event interval in the second display region, and to display an event interval symbol, in particular a bar symbol, between the determined starting position and the determined ending position.

One advantageous embodiment provides that the first display region and the second display region are arranged connecting to one another, in particular adjacent to one another, wherein the second display region is preferably arranged to the right of the first display region.

One further subject matter of the invention is a food treatment machine, in particular a food processing machine or a food packaging machine, having display equipment as described in the foregoing.

The food treatment machine can be embodied, for example, as a cutting machine, defroster, cutter, mixer, thermoform packaging machine, vertical form fill seal machine, and horizontal form fill seal machine.

The food treatment machines can be suitable for meats, poultry, fish/seafood, cheese, meat alternatives, protein replacement products as from insects or mushrooms, cultured meats, vegetables, pizza, bread, pastries, baked goods, cookies, and the like. The food treatment machine embodied as a food processing machine, in particular as a meat processing machine, can be embodied as a defroster, cutting machine, mixer, tumbler, grinder, emulsifier, marinating machine, kneader, meat injector, filtration machine for brine and/or meat additives, cooler for brine, meat press, freezer, defroster, tenderizer, shaker, fat analysis machine, pump, crusher, forming or portioning machine, coating machine such as dough/breading/crumb/cooking oil machine, dedusting machine, drying/boiling/brewing/frying/steaming/sous vide machine, fryer, grill, smoker, fry oil filter machine, oven/heating/range system, grocery scanner, slicer, scale, system for detecting foreign bodies such as metal/plastic/bones, cleaning system for the food contact region, e.g. for injection needles, or transport system, filling/loading and/or unloading system and/or conveying system and/or metering system. The food treatment machine embodied as a food packaging machine can be embodied as a thermoform packaging machine, vertical flow pack machine or horizontal flow pack machine, bottle filling machine, filling machine, labeler/printer, lollipop molding/cooling/wrapping machine, lollipop packaging machine, sugar cube molding/drying/packaging machine, distributor. Alternatively, the food treatment machine can be an automation/control/line control system for one or a plurality of the aforesaid machines.

The same advantages can be achieved for the display equipment and the food treatment machine as were already explained in connection with the inventive method. The advantageous embodiments and features described in connection with the method can also be used, alone or in combination, with the display equipment and the food treatment machine.

One embodiment of the food treatment machine has proved advantageous in which the food treatment machine is designed to receive the time history of the key parameter from a further food treatment machine and to display said time history in the display equipment. Such an embodiment offers the advantage that a key parameter of a second food treatment machine that is, for example, in a line upstream of the first food treatment machine, can be displayed in the display equipment of a first food treatment machine. This key parameter can be displayed in the display equipment of the first food treatment machine together with an event of the first food treatment machine.

Alternatively or in addition, it can be provided for the inventive food treatment machine that the food treatment machine is designed to receive an event from a further food treatment machine and to determine for the event an event position in the first display region and to display an event symbol at the determined event position in the first display region. This makes it possible to display the key parameter of the second food treatment machine in the display equipment of the first food treatment machine together with the event of the second food treatment machine. Furthermore, a key parameter of the first food treatment machine can be displayed in the display equipment together with an event of the second food treatment machine.

### BRIEF DESCRIPTION OF THE FIGURES

Further details, features, and advantages of the invention may be found in the drawings, and in the following description of the preferred embodiments with the drawings. The drawings merely illustrate embodiments of the invention and do not limit the inventive thought.

FIG. 1 is a schematic depiction of a display that is shown with a method for displaying a key parameter according to one exemplary embodiment of the invention.

FIG. 2 is a schematic depiction of a further display that is shown with a method for displaying a key parameter according to one exemplary embodiment of the invention.

FIG. 3 is a schematic depiction of a further display that is shown with a method for displaying a key parameter according to one exemplary embodiment of the invention.

FIG. 4 is a schematic depiction of a further display that is shown with a method for displaying a key parameter according to one exemplary embodiment of the invention.

### DETAILED DESCRIPTION

Equivalent parts are always provided with the same reference numbers in the various figures and as a rule are therefore only identified or mentioned once.

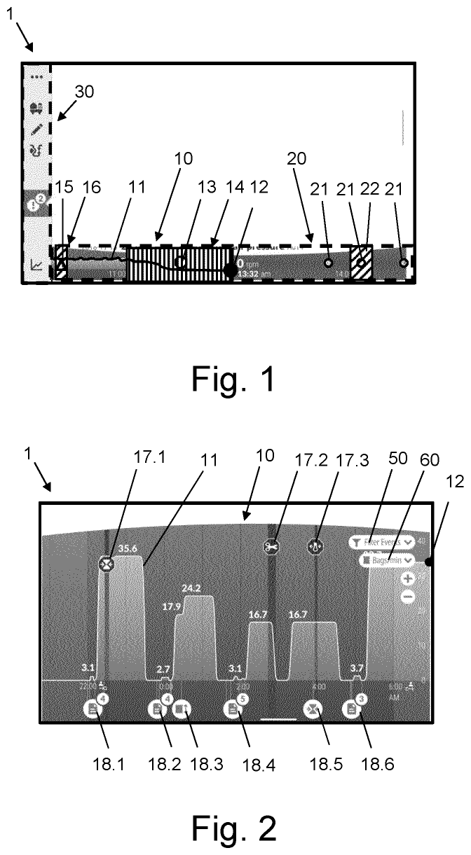

The depiction in FIG. 1 shows a display of display equipment 1 for a food treatment machine, in particular a food processing machine or a food packaging machine. The display equipment 1 according to the exemplary embodiment comprises a touch-sensitive screen with a screen surface area. Information can be displayed thereon and inputs of a user, for example touches on certain regions of the screen or swipe gestures, can be detected.

The display equipment 1 is designed to display a time history 11 of a key parameter from a first time in the past to a current time in a first display region 10 of the display equipment 1. The first display region 11 is arranged on the lower end of the screen surface area of the display equipment 1. The history 11 is depicted as a curve over time. The current time is marked by a marking 12 embodied as a point or filled circle. In the present exemplary embodiment, the key parameter is a speed of a component in the food treatment machine.

As can further be seen from the depiction in FIG. 1, the display equipment 1 is furthermore designed to determine an event position in the first display region for at least one event that occurred between the first time and the current time, and to display an event symbol 13, 14 at the determined event position in the first display region. In the present case, a plurality of (here, exactly two) event symbols 13, 14 are displayed in the first display region 10.

A first event symbol 13 symbolizes an event that occurred between the first time and the current time. The first event symbol 13 is designed like a STOP sign. In the inventive method, first an event position that corresponds to the time of the event relative to the time history 11 of the key parameter is determined in the first display region 10. Then the event symbol 13 corresponding to the event is displayed at the determined event position in the first display region 10. In addition, an event interval that identifies a temporal range in which the event was continuously present is allocated to this event. To make it possible to display this event interval, in the inventive method first a starting position for the event interval and an ending position for the event interval are determined in the first display region 10. Then a first event interval symbol 14, in this case a bar symbol, is displayed between the determined starting position and the determined ending position.

A second event symbol 15 symbolizes a further event that occurred between the first time and the current time. This second event symbol is embodied like a triangular warning sign. An event interval for which initially a starting position for the event interval and an ending position for the event interval are determined in the first display region is also allocated to the second event. Then a second event symbol 16, in this case a bar symbol, is displayed between the determined starting position and the determined ending position.

In addition, a priority is allocated to the first and second events. A display color is to each event symbol 13, 15 and to each event interval symbol 14, 16 using the priority of the associated event. The display of the event symbol 13, 15 and event interval symbol 14, 16 is then provided in the determined display color. In the present exemplary embodiment an event symbol type, in this case either a symbol like an octagonal STOP sign or a symbol like a triangular warning sign, is determined using the priority.

A second display region 20 connected to the first display region 10 to the right thereof is also provided in the display equipment 1. Thus, the second display region 20 is also arranged at the lower end of the screen surface area of the display equipment 1. No time history of the key parameter is displayed in the second display region 20. However, an event position is determined in the second display region 20 for each of a plurality of future events, in particular planned or forecasted events, and an event symbol 21 is displayed at each determined event position in the second display region 20. The distance between this event symbol 21 and the marking 12 of the current time depends on how far in the future each future event lies.

An event interval is also allocated to one of the future events. As already explained in connection with the first display region, a starting position and an ending position in the second display region 20 are determined for this event interval and an event interval symbol 22, in this case a bar symbol, is displayed between the determined starting position and the determined ending position.

According to the exemplary embodiment, a third display region 30 embodied as a menu bar and comprising a plurality of menu symbols is also provided on the display equipment. It can be provided that first and second display regions 10, 20 and/or the third display region 30 are always visible when the display equipment 1 is activated.

FIG. 2 depicts a first display region of display equipment operated according to a method in accordance with a further exemplary embodiment of the invention. This display device is initially disposed in a first depiction status in which, as shown in FIG. 1, for example, the first display region is depicted relatively small on the lower end of the screen surface area. In this status, further information can be displayed on the screen surface area above the first display region. If a user now touches the display equipment 1 or performs a swiping gesture on the display equipment 1, there is a change between the first depiction status and a second depiction status that is illustrated in FIG. 2. In this second depiction status, the first display region 10 and also the second display region 20 are depicted larger than in the first depiction status. In addition, in the second depiction status the history 11 of the key parameter is displayed with greater detail accuracy than in the first depiction status.

The depiction in FIG. 1 shows a plurality of event symbols 17.1-17.3, one event interval being allocated to each. Event interval symbols corresponding to the event symbols 17.1-17.3 are also illustrated. The event symbols 18.1-18.6 symbolize singular events that have taken place at a specific time prior to the current time (see marking 12).

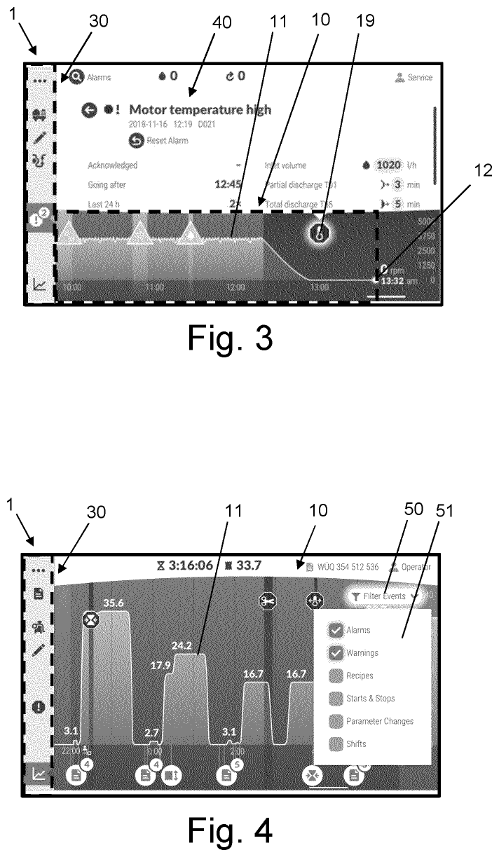

The depiction in FIG. 3 illustrates display equipment 1 operated according to a method in accordance with a further exemplary embodiment of the invention. In this exemplary embodiment, when an event symbol 19 is selected by a user, for example by touching the event symbol 19, contextual information 40 about the event is displayed in the display device 1. The contextual information 40 is displayed above the first display region 10.

FIG. 4 illustrates display equipment operated according to a method in accordance with a further exemplary embodiment of the invention. In this exemplary embodiment, an event type selection symbol 50 is displayed, and, when a user selects the event type selection symbol 50, for example by touching it, an event type list 51 is displayed. The event type list opens in the manner of a drop-down menu when the event type selection symbol 50 is selected. When a user selects an event type from the event type list 51, only events of the selected event type or types are displayed in the first display region 10.

According to a modification of the exemplary embodiments depicted in the drawing, it can be provided that a key parameter selection symbol 60 is displayed in the display equipment, and, when a user selects the key parameter selection symbol 60, the key parameter list is displayed (see FIG. 2). When user selects a key parameter from the key parameter list, a time history 11 of the selected key parameter from the first time in the past to the current time is then displayed in the first display region 10 of the display equipment.

In the display equipment 1 described in the foregoing, a method can be used for displaying a key parameter of a food treatment machine, in particular a food processing machine or a food packaging machine, by means of display equipment 1 of the food treatment machine, wherein a time history 11 of the key parameter from a first time in the past to a current time is displayed in a first display region 10 of the display device 1, and wherein, for at least one event that occurred between the first time and the current time, an event position in the first display region 10 is determined and an event symbol 13, 15, 17.1-17.3, 18.1-18.6, 19 is displayed at the determined event position in the first display region 10. This makes it easier for a user to detect the current status of the food treatment machine, in particular following a change in user or a shift change.

### LIST OF REFERENCE SYMBOLS

1 Display equipment
10 First display region
11 Time history of the key parameter
12 Marking of the current time
13 Event symbol
14 Event interval symbol
15 Event symbol
17.1-17.3 Event symbol
18.1-18.6 Event symbol
19 Event symbol
20 Second display region
21 Event symbol
22 Event interval symbol
30 Third display region
40 Fourth display region, contextual information
50 Event type selection symbol
51 Event type list
60 Key parameter selection symbol

1. Method for displaying a key parameter of a food treatment machine, a food processing machine, or a food packaging machine, by means of display equipment on the food treatment machine, wherein the method comprises: displaying a time history of the key parameter from a first time in the past to a current time in a first display region of the display equipment,
wherein for at least one event that has occurred between the first time and the current time, determining an event position in the first display region, and displaying an event symbol at the determined event position in the first display region.

2. Method according to claim 1, wherein an event interval is allocated to the at least one event, wherein a starting position for the event interval and an ending position for the event interval in the first display region are determined, and an event interval symbol, is displayed between the determined starting position and the determined ending position.

3. Method according to claim 1, wherein a marking is displayed at the current position corresponding to the current time.

4. Method according to claim 1, wherein the display equipment has a second display region, wherein an event position for at least one future event, in the second display region is determined and an event symbol is displayed at the determined event position in the second display region.

5. Method according to claim 4, wherein an event interval is allocated to the at least one event, wherein a starting position for the event interval and an ending position for the event interval in the first display region are determined and an event interval symbol is displayed between the determined starting position and the determined ending position.

6. Method according to claim 4, wherein the first display region and the second display region are arranged adjacent to one another, wherein the second display region is preferably to the right of the first display region.

7. Method according to claim 4, wherein the event interval symbol extends from the first display region into the second display region.

8. Method according to claim 1, wherein the display device comprises a touch-sensitive screen.

9. Method according to claim 1, wherein when the event symbol is selected by a user by touching the event symbol, contextual information about the event is displayed in the display device.

10. Method according to claim 1, wherein when a user touches the display equipment or performs a swiping gesture on the display equipment, there is a switch back and forth between a first depiction status and a second depiction status, wherein in the first depiction status the first display region and the second display region are depicted smaller than in the second depiction status.

11. Method according to claim 10, wherein the history of the key parameter is displayed with a lower detail accuracy in the first depiction status than in the second depiction status.

12. Method according to claim 1, wherein a priority is allocated to the at least one event, wherein a display color is determined using the priority and the event symbol and the event interval symbol are displayed in the determined display color.

13. Method according to claim 1, wherein a key parameter list of prespecified key parameters is displayed in the display equipment, wherein when a user selects a key parameter from the key parameter list, a time history of the selected key parameter from the first time in the past to the current time is displayed in the first display region.

14. Method according to claim 13, wherein a key parameter selection symbol is displayed in the display equipment, and when a user selects the key parameter selection symbol, the key parameter list is displayed.

15. Display equipment for a food treatment machine, a food processing machine, or a food packaging machine, that is configured to display a time history of a key parameter from a first time in the past to a current time in a first display region of the display equipment,
wherein the display equipment is further configured to determine an event position in the first display region for at least one event that occurred between the first time and the current time, and to display an event symbol at the determined event position in the first display region.

16. Display equipment according to claim 15, wherein an event interval is allocated to the at least one event and the display equipment is further designed to determine a starting position for the event interval and an ending position for the event interval in the first display region, and to display an event interval symbol between the determined starting position and the determined ending position.

17. Display equipment according to claim 15, wherein the display equipment has a second display region, wherein the display equipment is further designed to determine for at least one future event an event position in the second display region, and to display an event symbol at the determined event position in the second display region.

18. Display equipment according to claim 15, wherein an event interval is allocated to the at least one event, wherein the display equipment is further configured to determine a starting position for the event interval and an ending position for the event interval in the first display region, and to display an event interval symbol between the determined starting position and the determined ending position.

19. Display equipment according to claim 15, wherein the first display region and the second display region are arranged connecting to one another, wherein the second display region is arranged to the right of the first display region.

20. Food treatment machine, a food processing machine, or a food packaging machine, comprising the display equipment according to claim 15.

21. Food treatment machine according to claim 20, wherein the food treatment machine is configured to receive the time history of the key parameter from a further food treatment machine and to display the time history of the key parameter from the further food treatment machine in the display equipment.

22. Food treatment machine according to claim 20, wherein the food treatment machine is configured to receive an event from a first food treatment machine and to determine an event position for the event in the first display region and to display an event symbol at the determined event position in the first display region.
